(19) United States
(12) Patent Application Publication
(10) Pub. No.: US 2003/0019562 A1
(43) Pub. Date: Jan. 30, 2003

(54) Adhesive bonding of printed circuit boards to heat sinks

(76) Inventor: Kunno John Warn, Granby, CT (US)

Correspondence Address: Gregory R. Stephenson, One Hamilton Road, MS-1-1-BC18, Windsor Locks, CT, 06096-1010, US

(21) Appl. No.: 10/247,385

(22) Filed: Sep. 19, 2002

Related U.S. Application Data
(63) Continuation of application No. 09/631,476, filed on Aug. 3, 2000, now abandoned.

(51) Int. Cl. B32B 31/00

(52) U.S. Cl. 156/87; 156/286

(57) ABSTRACT

Voids (26) at the interface of a printed circuit board (10) bonded to a heat sink (24) which impede heat transfer from a heat generating electronic component (12) mounted on the printed circuit board (10) to the heat sink (24), and thus limit the density of electronic components (12) that may be mounted to a given printed circuit board (10) are avoided by a method wherein the adhesive securing the printed circuit board (10) to the heat sink (24) is formed of a pressure sensitive adhesive layer (22) and a thermosetting adhesive layer (28). The latter fills the voids and thus provides for greater thermal conductivity from a heat generating component (12) to the heat sink (24) with the result in increase in heat rejection (30).

This application is a continuation of pending U.S. patent application Ser. No. 09/631,476, which was filed on Aug. 3, 2000.

### FIELD OF THE INVENTION

This invention relates to printed circuit board and heat sink assemblies wherein the two are bonded together, and to a method of bonding printed circuit boards to heat sinks.

### BACKGROUND OF THE INVENTION

The long standing desire for miniaturization of electronic components has led to an increase in the number of electronic components mounted on a printed circuit board of a given size. As a consequence of this long standing trend, heat dissipation has become evermore important. Many printed circuit boards in use today mount hundreds of electronic components which are interconnected by printed layers of conductors, frequently referred to as copper traces. Of these components, many generate substantial quantities of heat which must be dissipated so as to avoid shortening the life of the printed circuit board and the components mounted thereon.

As a consequence, the prior art has turned to mounting printed circuit boards on heat sinks, typically bodies of aluminum or other highly conductive metal, which absorb heat rejected by the heat generating components on the printed circuit board and dissipate it to the ambient or to a heat exchange fluid in heat exchange relation with the heat sink. Not infrequently, so-called thermal pads are interposed between the heat generating component on the printed circuit board and the heat sink at the interface of the two to improve the rate of heat transfer from the heat rejecting component to the heat sink.

The prior art has typically employed a pressure sensitive adhesive, usually an acrylic based pressure sensitive adhesive, to secure the printed circuit boards to their respective heat sinks. This material provides good adhesion, relatively good thermal conductivity and a measure of vibration isolation when the printed circuit boards are utilized in environments subject to vibration. However, the material is not particularly flowable and inasmuch as the copper traces and thermal pads typically extend from the surface of the printed surface board a distance on the order of 0.002-0.003 inches, pockets that do not contain the pressure sensitive adhesive exist between adjacent copper traces and/or thermal pads.

These pockets or voids act as insulating spaces and thereby reduce the heat transfer rate between the heat generating components and the heat sink. They may also reduce the adhesion between the heat sink and the printed circuit board that would otherwise be present were the voids eliminated.

Unfortunately, the application of a vacuum to the pressure sensitive adhesive containing interface of a printed circuit board and a heat sink during assembly does not appreciably reduce the voids. The voids can typically account for 40% or more of the space between the printed circuit board and the heat sink. They are not filled because the pressure sensitive adhesive is not particularly flowable as mentioned above and the copper traces and thermal pads act much like a labyrinth seal to prevent air or other gas located in the pockets between the copper traces and/or thermal pads from being extracted by the vacuum.

Consequently, even in assemblies of printed circuit boards and heat sinks, the density of electronic components mounted on a given printed circuit board is limited because of the inability to increase thermal conductivity to the point necessary to assure rejection of heat generating electronic components at a necessary rate.

The present invention is directed to overcoming the above problem.

### SUMMARY OF THE INVENTION

It is a principal object of the invention to provide a new and improved method of bonding printed circuit boards to heat sinks. It is also a principal object of the invention to provide a new and improved bonded, printed circuit board/heat sink assembly.

According to one aspect of the invention, there is provided a method of bonding a printed circuit board to a heat sink which includes the steps of a) sandwiching at least one layer of pressure sensitive adhesive and at least one layer of thermosetting adhesive between the heat sink and the printed circuit board with a layer of pressure sensitive adhesive contacting the heat sink and a layer of thermosetting adhesive contacting the printed circuit board; b) compacting the assembly resulting from step a) under vacuum to remove gas between the layers of adhesive and the heat sink and circuit board; and c) applying heat to the assembly resulting from step a) during or after the performance of step b) to cure the thermosetting adhesive.

In a highly preferred embodiment, step a) is performed by locating an adhesive composite containing the layers between the printed circuit board and the heat sink.

Preferably, the step of compacting the assembly under vacuum and the steps of applying heat to the assembly are performed concurrently.

In a highly preferred embodiment, an adhesive composite is rolled or otherwise pressed onto the heat sink prior to the assembly of the printed circuit board thereto to eliminate gas in the sandwich of components.

According to another facet of the invention, there is provided a printed circuit board and heat sink assembly which includes a printed circuit board, a heat sink having a printed circuit board receiving surface based from the printed circuit board, and at least one layer of pressure sensitive adhesive bonded to the heat sink. The assembly further includes at least one layer of thermosetting adhesive which is bonded to the printed circuit board. The adhesive layers are adhered to each other and fill the space between the heat sink and the printed circuit board with the filled space being characterized by the substantial absence of gas pockets or voids.

Other objects and advantages will become apparent from the following specification taken in connection with the accompanying drawings.

### DESCRIPTION OF THE DRAWINGS

FIG. 1 is a fragmentary, sectional view of a printed circuit board/heat sink assembly made according to the prior art;

FIG. 2 is a view similar to FIG. 1 but illustrating such an assembly made according to the present invention; and

FIG. 3 is a flow diagram illustrating a sequence of steps used in a preferred embodiment of the method of the present invention.

### DESCRIPTION OF THE PREFERRED EMBODIMENT

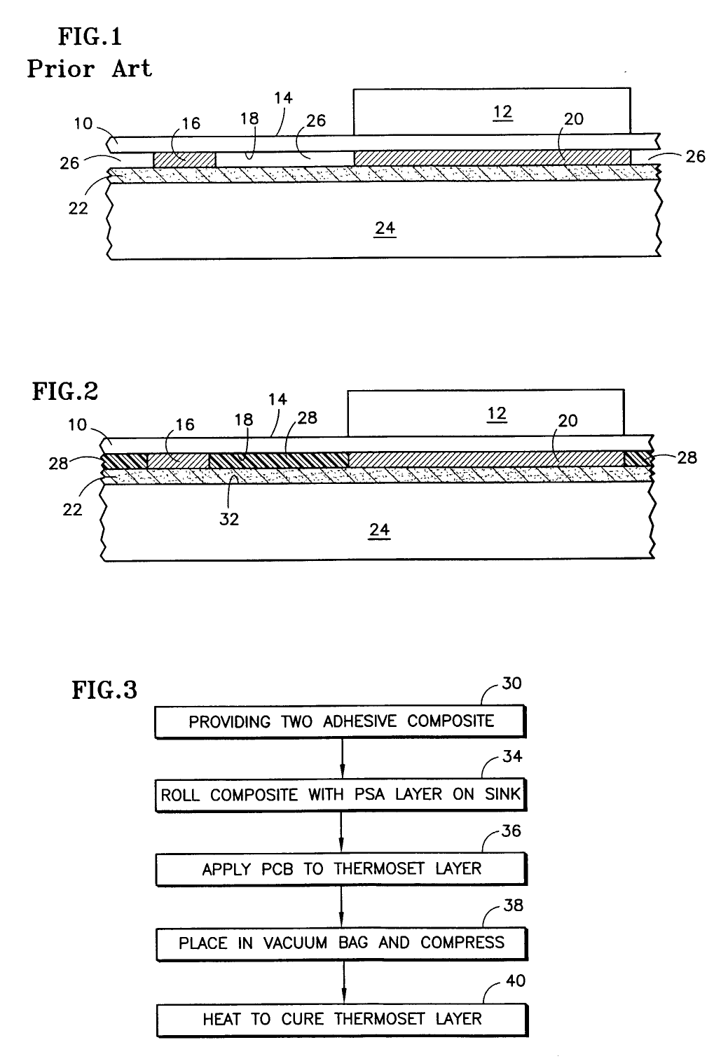

Referring to FIG. 1, a prior art construction of a printed circuit board/heat sink assembly is illustrated. The same is seen to include a printed circuit board 10 of conventional construction which mounts at least one heat generating electronic component 12 on one side 14 thereof. The printed circuit board 10 includes copper traces 16 (only one of which is shown) which, as is well known, serve as electrical conductors between the various electronic components mounted on the printed circuit board 10. It will be particularly observed that the copper trace 16 illustrated in FIG. 1 extends somewhat from the side 18 of the printed circuit board 10 opposite the side 14. As mentioned previously, the extension will typically be in the range of 0.002-0.003 inches.

Also on the printed circuit board 10 is a thermal pad 20 of conventional construction and typically formed of a thin layer of copper or the like.

A layer of acrylic based pressure sensitive adhesive 22 is located adjacent the side 18 of the printed circuit board 10 and in contact with the copper traces 16 and the thermal pads 20 and bonds a conventional heat sink 24 thereto. In the usual case, voids 26 will exist between the copper traces 16 and/or the thermal pads 20 as mentioned previously. This is due to the fact that the pressure sensitive adhesive 22 is not particularly flowable and cannot be caused, in conventional processing, to fill the voids 26.

Turning now to FIG. 2, a printed circuit board/heat sink assembly made according to the invention is illustrated. Where like components are employed, they are given the same reference numerals given to the prior art construction in FIG. 1 and will not be redescribed. The principal difference is the fact that the voids 26 have been substantially filled with bodies 28 of an adhesive. In the usual case, voids will occupy less than 5% of the space between the circuit board 10 and the heat sink 24. The adhesive bodies 28 are typically formed of a thermosetting epoxy adhesive which is flowable and then cured in place.

Turning now to FIG. 3, a highly preferred embodiment of the method by which the assembly illustrated in FIG. 2 is formed will be described. However, it is to be understood that while the embodiment described represents the best mode contemplated by the inventors, variations in the method are contemplated and no limitation to the highly preferred embodiment to be described is intended except insofar as set forth in the appended claims.

An initial step in the method is illustrated by a box 30 which is the provision of a two adhesive composite. In the preferred embodiment, the composite is formed of two layers of adhesive, one of pressure sensitive adhesive and the other of a thermosetting adhesive. However, more than one layer of each type of adhesive may be employed if desired. It is, however, important, that the composite have one face that is formed of the pressure sensitive adhesive 22 and the other of the thermosetting adhesive 28. Suitable pressure sensitive adhesives include acrylic based pressure sensitive adhesives available from Minnesota Mining and Manufacturing (3M Corporation) as 3M 9460 and 3M 9469. The thermosetting adhesive 28 may be an epoxy based-adhesive which will adhere to the pressure sensitive adhesive 22 and is also available from 3M Corporation as AF 163. Alternate thermosetting adhesives 28 are also suitable.

In the usual case, a release liner (not shown) will be applied to the pressure sensitive adhesive layer. A similar release liner might also be applied to the layer of thermosetting adhesive but such is generally not necessary where the thermosetting adhesive, in its uncured state, is virtually solid and not particularly tacky. Such will typically be the case for thermosetting adhesives such as that identified above. As pressure sensitive adhesives identified are typically acrylic based, they provide a measure of vibration isolation (damping) just as in the prior art construction.

The release liners are then removed and the pressure sensitive adhesive layer 22 applied to a printed circuit board receiving surface 32 of the heat sink 24. The adhesive composite is then compressively rolled onto the surface 32 to achieve adherence thereto and to eliminate any gas pockets or bubbles that may form in the application process when the composite with the layer 22 is applied to the surface 32. This step is illustrated at a box labeled 34.

At this point in the process, the printed circuit board is applied to the thermosetting adhesive layer as illustrated at a box 36. The resulting assembly is then placed in a conventional vacuum bag and subject to vacuum. This operation performs two functions. A first is to draw air or gas out of the pockets 26 as would otherwise exist. A second purpose is to cause the vacuum bag to collapse upon the assembly and compress it so as to drive the copper tracer 16 and the thermal pads 20 against the layer of thermosetting adhesive to form the bodies illustrated in FIG. 2 as shown by the box 38.

The assembly is then heated as shown by a box 40. Initially the heating of the thermosetting adhesive lowers its viscosity, causing the same to liquify and flow into the pockets 26 that were previously evacuated by the step performed at the box 38. At the same time curing of the resin is initiated. When curing is complete the thermosetting adhesive will have formed the rigid bodies 28. Preferably the thermosetting resin will liquify and cure at temperatures on the order of 200 [symbol] F. This temperature is sufficient to achieve a cure while at the same time, insufficient to cause thermal damage to the circuit board and the electronic components mounted thereon.

The assembly may then be removed from the vacuum bag and stored as inventory or shipped to a point of use.

In the usual case, the thickness of the layers of both the thermosetting adhesive and the pressure sensitive adhesive will be in the range of 0.002-0.010 inches. A preferred embodiment contemplates a thickness of about 0.005 inches for each layer.

In general, it is desirable to make the layers as thin as possible to achieve adequate adhesion. The adhesive layers are not particularly good thermal conductors as would be the case with metal such as copper or aluminum and accordingly, increasing their thickness will reduce the rate of heat rejection through them. At the same time the pressure sensitive adhesive layer 22 should be sufficiently thick to provide the desired vibration isolation or damping required for a given application.

It has been found that while the prior art construction such as illustrated in FIG. 1 may have voids such as the voids 26 occupying 40% or more of the space between the printed circuit board 10 and the heat sink 24, if the assembly is formed according to the present invention, the void space can be reduced to at least 5%, and as low as 0%, thereby substantially effectively removing the voids 26 as an impediment to heat transfer from the printed circuit board 10 to the heat sink 24.

As a consequence, not only is adhesion between the heat sink 24 and the printed circuit board 10 improved by the absence of voids, the thermal conductivity is greatly increased by reason of the reduction of the volume occupied by the voids 26 which act as insulating pockets to impede heat transfer.

It is to be particularly noted that the provision of a composite as step 30 is a highly preferred step in the practice of the invention but not an altogether necessary one. The use of a composite allows a sheet of the composite to be readily cut as by laser cutting to a the desired size. Furthermore, it reduces handling problems. Nonetheless, it is contemplated that the adhesive layers could be applied individually to the respective components and to each other if desired.

It should also be appreciated that in a preferred embodiment, the step of subjecting the assembly to a vacuum and compressing it represented by box 38 and the step of heating the assembly represented by step 40 need not be performed in the sequence illustrated in FIG. 3. In fact, it is preferable that both the vacuum/compression step and the heating step be performed simultaneously, again to speed processing and minimize handling.

Finally, it should also be appreciated that the rolling step represented by box 34 may be omitted if the method by which the layers are applied does not result in the formation of bubbles between the layers of adhesive or between the adhesive layers and the heat sink 24 or circuit board 10.

From the foregoing, it will be appreciated that a method of making a bonded printed circuit board/heat sink assembly made according to the invention provides a vast improvement in the resulting product in terms of allowing an increase in the density of electronic components mounted on the board 10 by providing the capability of heat rejection to the heat sink at a more rapid rate. Furthermore, the adhesion of the printed circuit board to the heat sink is improved. Thus, the invention provides not only a highly advantageous method of making such assemblies, but an improved assembly as well.

I claim:

1. A method of bonding a printed circuit board to a heat sink comprising the steps of:
a) providing an adhesive composite having at least one exposed layer of pressure sensitive adhesive and at least one exposed layer of thermosetting adhesive;
b) sandwiching the composite between a printed circuit board and a board receiving surface on a heat sink with the exposed layer of pressure sensitive adhesive facing said board receiving surface and the exposed layer of thermosetting adhesive facing the printed circuit board;
c) subjecting the assembly resulting from step b) to both a vacuum and heat to remove gas between the heat sink and the printed circuit board and to cure the thermosetting adhesive.

2. The method of claim 1 where step a) is succeeded by and step b) is preceded by the step of compacting the adhesive composite to remove gas bubbles.

3. The method of claim 2 wherein the step of compacting includes compacting the adhesive composite against the heat sink.

4. The method of claim 3 wherein step c) also includes compressing the assembly resulting from step b).

5. The method of claim 1 wherein step c) also includes compressing the assembly resulting from step b).

6. A printed circuit board and heat sink assembly made according to the method of claim 1.

7. A method of bonding a printed circuit board having at least one heat generating component mounted thereon to a heat sink comprising the steps of:
a) sandwiching at least one layer of pressure sensitive adhesive and at least one layer of thermosetting adhesive between the heat sink and the printed circuit board with a pressure sensitive adhesive layer contacting the heat sink and a layer of thermosetting adhesive contacting the printed circuit board;
b) compacting the assembly resulting from step a) under vacuum to remove gas at or between the layers of adhesive; and
c) applying heat to the assembly resulting from step a) during or after the performance of step b) to cure the thermosetting adhesive.

8. The method of claim 7 wherein step a) is performed by locating an adhesive composite containing said layers between said printed circuit board and said heat sink.

9. The method of claim 1 wherein step c) is effective to additionally liquify the thermosetting adhesive to cause it to flow into void spaced on the printed circuit board caused by the vacuum.

10. A printed circuit board and heat sink assembly made according to the method of claim 7.

11. A printed circuit board and heat sink assembly comprising:
a) a printed circuit board;
b) a heat sink having a printed circuit board receiving surface spaced from said printed circuit board;
c) at least one layer of pressure sensitive adhesive and bonded to said heat sink;
d) at least one layer of thermosetting adhesive and bonded to said printed circuit board;
e) said adhesive layers being adhered to each other and filling the space between said heat sink and said printed circuit board;
f) said filled space being characterized by the substantial absence of gas pockets or voids.
